(19) United States
(12) Patent Application Publication
(10) Pub. No.: US 2012/0070157 A1
(43) Pub. Date: Mar. 22, 2012

(54) OMNI-DIRECTIONAL RADIATION-BASED SIGNAL TRANSMITTING APPARATUS

(75) Inventor: Jui-Kuang Fang, Taipei City (TW)

(73) Assignee: LIVINGLAB DEVELOPMENT CO., LTD., Taipei City (TW)

(21) Appl. No.: 12/963,641

(22) Filed: Dec. 9, 2010

(30) Foreign Application Priority Data
Sep. 16, 2010 (TW) 099217929

(51) Int. Cl. H04B 10/04

(52) U.S. Cl. 398/182

(57) ABSTRACT

The invention provides an omni-directional radiation-based signal transmitting apparatus which includes a circuit board and a plurality of radiation-based signal transmitting components. In particular, the radiation-base signal transmitting components are soldered and arranged on the circuit board such that the signal coverage zone of each radiation-based signal transmitting component overlaps the signal coverage zones of the neighboring radiation-based signal transmitting components.

### CROSS-REFERENCE TO RELATED APPLICATION

This utility application claims priority to Taiwan Application Serial Number 099217929, filed Sep. 16, 2010, which is incorporated herein by reference.

### BACKGROUND OF THE INVENTION

1. Field of the Invention

The invention relates to an omni-directional radiation-based signal transmitting apparatus.

2. Description of the Prior Art

Using radiation-based signal to achieve the remote control function is pervasively applied in all kinds of electronic products. For example, infrared remote control function is applied in a variety of home appliances.

However, radiation-based signal transmitting component such as infrared transmitters are limited by physics principle, package structure, etc., such that the signal coverage zone of the signal transmitting component is a narrow cone zone. Take an ordinary commercial infrared light-emitting diode for example, its signal coverage zone is usually a cone zone with a 35° cone angle. Therefore, prior arts using a radiation-based signal transmitting component to achieve the remote control function are mostly applied in hand-held remote controllers which have narrow signal coverage zones and quite large dead zones.

Presently, none of the prior arts using radiation-based signal transmitting components to achieve the remote control function uses the solution of omni-directional radiation-based signal transmitting without dead zone. Solution of omni-directional radiation-based signal transmitting without dead zone can be used to remotely control all electronic products in the place, an to ensure the certainty of the remote control function.

### SUMMARY OF THE INVENTION

Accordingly, a scope of the invention is to provide an omni-directional radiation-based signal transmitting apparatus to achieve omni-directional transmitting of radiation-based signals without dead zone for signal coverage, and to ensure the certainty of the remote control function.

An omni-directional radiation-based signal transmitting apparatus according to a preferred embodiment of the invention includes a circuit board, a driving circuit, N first radiation-based signal transmitting components, M second radiation-based signal transmitting components, and at least one third radiation-based signal transmitting component, where N is an integer lager than or equal to 6, and M is an integer lager than or equal to 6. The circuit board thereon defines a planar direction. The driving circuit is soldered on the circuit board. Each first radiation-based signal transmitting component has a respective first transmitting central axis and a respective first signal coverage zone around the first transmitting central axis. Particularly, the first radiation-based signal transmitting components are soldered on the circuit board and surrounding into a first closed shape such that the first transmitting central axis of each first radiation-based signal transmitting component makes a first angle with the planar direction of the circuit board and the first signal coverage zone of each first radiation-based signal transmitting component overlaps the first signal coverage zones of the neighboring first radiation-based signal transmitting components. Each first radiation-based signal transmitting component is electrically connected to the driving circuit through the circuit board. Each second radiation-based signal transmitting component has a respective second transmitting central axis and a respective second signal coverage zone around the second transmitting central axis. The second radiation-based signal transmitting components are soldered on the circuit board and surrounding into a second closed shape such that the second transmitting central axis of each second radiation-based signal transmitting component makes a second angle with the planar direction of the circuit board and the second signal coverage zone of each second radiation-based signal transmitting component overlaps the second signal coverage zones of the neighboring second radiation-based signal transmitting components. Each second radiation-based signal transmitting component is electrically connected to the driving circuit through the circuit board. Each third radiation-based signal transmitting component has a respective third transmitting central axis and a respective third signal coverage zone around the third transmitting central axis. The at least one third radiation-based signal transmitting component is soldered on the circuit board such that the third transmitting central axis of each third radiation-based signal transmitting component is parallel to the planar direction of the circuit board and the third signal coverage zone of each third radiation-based signal transmitting component overlaps the third signal coverage zones of the neighboring third radiation-based signal transmitting components. Each third radiation-based signal transmitting component is electrically connected to the driving circuit through the circuit board. The driving circuit is for driving the first radiation-based signal transmitting components, the second radiation-based signal transmitting components and the at least one third radiation-based signal transmitting component simultaneously emitting radiation-based signals.

In an embodiment, the first closed shape is a first circle, the second closed shape is a second circle located within the first circle, and the at least one third radiation-based signal transmitting component is located within the second circle.

In an embodiment, the second signal coverage zone of each second radiation-based signal transmitting component overlaps the first signal coverage zones of the neighboring first radiation-based signal transmitting components and the third signal coverage zones of the neighboring third radiation-based signal transmitting components.

In an embodiment, the first radiation-based signal transmitting components, the second radiation-based signal transmitting components and the at least one third radiation-based signal transmitting component are an infrared transmitter respectively.

In an embodiment, furthermore, the first signal coverage zone of each first infrared transmitter is a first cone zone with a 35° cone angle, and N is an integer larger than or equal to 14. The first angle is about 80°.

In an embodiment, furthermore, the second signal coverage zone of each second infrared transmitter is a second cone zone with a 35° cone angle, and M is an integer larger than or equal to 8. The second angle is about 60°.

In an embodiment, the third signal coverage zone of each third infrared transmitter is a third cone zone with a 35° cone angle.

Compared with prior arts, the omni-directional radiation-based signal transmitting apparatus according to the invention can achieve the function of omni-directional radiation-based signal transmitting without dead zone for signal coverage which prior arts can not achieve, and can ensure the certainty of the remote control function.

The advantage and spirit of the invention may be understood by the following recitations together with the appended drawings.

### BRIEF DESCRIPTION OF THE APPENDED DRAWINGS

FIG. 1A is an exterior view of an omni-directional radiation-based signal transmitting apparatus according to the preferred embodiment of the invention.

FIG. 1B is a circuit chart of the omni-directional radiation-based signal transmitting apparatus in FIG. 1A.

### DETAILED DESCRIPTION OF THE INVENTION

The invention provides an omni-directional radiation-based signal transmitting apparatus to achieve the function of omni-directional radiation-based signal transmitting without dead zone for signal coverage which prior arts can not achieve. Thereby, the omni-directional radiation-based signal transmitting apparatus of the invention can be used to remotely control all electronic products in that place, and to ensure the certainty of the remote control function. An embodiment of the invention explains sufficiently the features, spirit, advantages, and the convenient implementation of it.

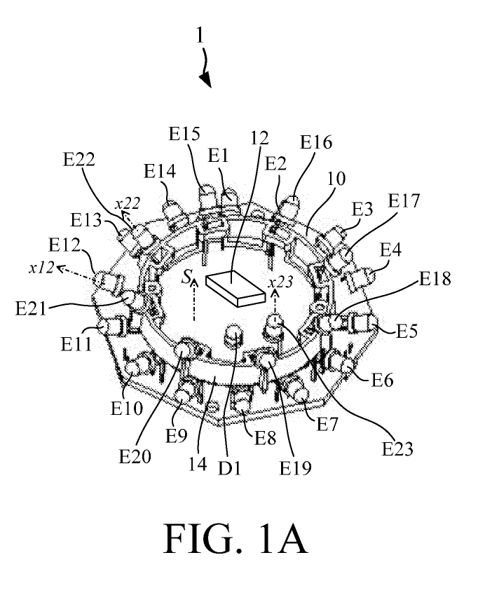

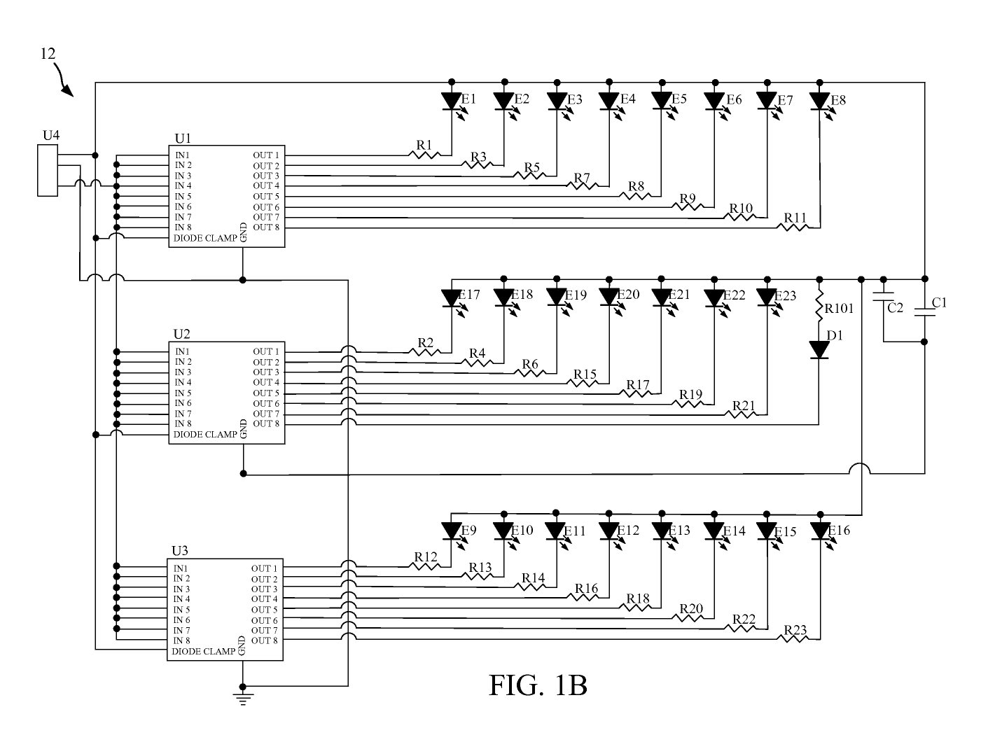

Please refer to FIG. 1A and FIG. 1B, since a preferred embodiment of the invention is elaborately illustrated therein. FIG. 1A is an exterior view of an omni-directional radiation-based signal transmitting apparatus 1 according to the preferred embodiment of the invention. FIG. 1B is a circuit chart of the omni-directional radiation-based signal transmitting apparatus 1 in FIG. 1A.

As shown in FIG. 1A, the an omni-directional radiation-based signal transmitting apparatus 1 according to a preferred embodiment of the invention includes a circuit board 10, a driving circuit 12, N first radiation-based signal transmitting components, M second radiation-based signal transmitting components, and at least one third radiation-based signal transmitting component, where N is an integer larger than or equal to 6, and M is an integer lager than or equal to 6. For example, the components with reference numerals E1˜E14 represent the first radiation-based signal transmitting components. The components with reference numerals E15˜E22 represent the second radiation-based signal transmitting components. The component with reference numeral E123 represents the third radiation-based signal transmitting component.

As well as shown in FIG. 1A, the circuit board 10 thereon defines a planar direction S. The driving circuit 12 is soldered on the circuit board 10.

As well as shown in FIG. 1A, each first radiation-based signal transmitting components (E1˜E14) has a respective first transmitting central axis and a respective first signal coverage zone around the first transmitting central axis. For clarity, only the first transmitting central axis x12 of the first radiation-based signal transmitting component E12 is shown in FIG. 1A. Particularly, the first radiation-based signal transmitting components (E1˜E14) are soldered on the circuit board 10 and surrounding into a first closed shape such that the first transmitting central axis of each first radiation-based signal transmitting component (E1˜E14) makes a first angle with the planar direction S of the circuit board 10 and the first signal coverage zone of each first radiation-based signal transmitting component (E1˜E14) overlaps the first signal coverage zones of the neighboring first radiation-based signal transmitting components (E1˜E14). Each first radiation-based signal transmitting component (E1˜E14) is electrically connected to the driving circuit 12 through the circuit board 10.

As well as shown in FIG. 1A, each second radiation-based signal transmitting component (E15˜E22) has a respective second transmitting central axis and a respective second signal coverage zone around the second transmitting central axis. For clarity, only the second transmitting central axis x22 of the second radiation-based signal transmitting component E22 is shown in FIG. 1A. Particularly, the second radiation-based signal transmitting components (E15˜E22) are soldered on the circuit board 10 and surrounding into a second closed shape such that the second transmitting central axis of each second radiation-based signal transmitting component (E15˜E22) makes a second angle with the planar direction S of the circuit board 10 and the second signal coverage zone of each second radiation-based signal transmitting component (E15˜E22) overlaps the second signal coverage zones of the neighboring second radiation-based signal transmitting components (E15˜E22). Each second radiation-based signal transmitting component (E15˜E22) is electrically connected to the driving circuit 12 through the circuit board 10.

As well as shown in FIG. 1A, each third radiation-based signal transmitting component (E23) has a respective third transmitting central axis and a respective third signal coverage zone around the third transmitting central axis. For example, FIG. 1A shows a third transmitting central axis x32 of the third radiation-based signal transmitting component E23. The at least one third radiation-based signal transmitting component (E23) is soldered on the circuit board 10 such that the third transmitting central axis of each third radiation-based signal transmitting component (E23) is parallel to the planar direction S of the circuit board 10 and the third signal coverage zone of each third radiation-based signal transmitting component (E23) overlaps the third signal coverage zones of the neighboring third radiation-based signal transmitting component (E23). Each third radiation-based signal transmitting component (E23) is electrically connected to the driving circuit 12 through the circuit board 10.

In an embodiment, as shown in FIG. 1A, the first closed shape is a first circle. The second closed shape is a second circle located within the first circle. Besides, the at least one third radiation-based signal transmitting component (E23) is located within the second circle. Furthermore, the omni-directional radiation-based signal transmitting apparatus 1 according to the invention includes a substantially circular supporting board 14, as shown in FIG. 1A. The supporting board 14 is mounted on the circuit board 10. The supporting board 14 is for assisting the first radiation-based signal transmitting components (E1˜E14) and the second radiation-based signal transmitting components (E15˜E22) to be fixed on the circuit board 10 and to maintain the first angle and the second angle made by the first radiation-based signal transmitting components (E1˜E14) and the second radiation-based signal transmitting components (E15˜E22) with the planar direction S of the circuit board 10.

The driving circuit 12 is used for driving the first radiation-based signal transmitting components (E1˜E14), the second radiation-based signal transmitting components (E15˜E22) and the at least one third radiation-based signal transmitting component (E23) simultaneously emitting radiation-based signals.

In an embodiment, the second signal coverage zone of each second radiation-based signal transmitting component (E15˜E22) overlaps the first signal coverage zones of the neighboring first radiation-based signal transmitting components (E1˜E14) and the third signal coverage zones of the neighboring third radiation-based signal transmitting components (E23). Thereby, the omni-directional radiation-based signal transmitting apparatus 1 according to the invention can achieve the function of omni-directional transmitting of radiation-based signals without dead zone for signal coverage.

Furthermore, the circuit board 10 is configured to be mounted on a ceiling or a wall. As long as the coverage zone of the radiation-based signals emitted by the omni-directional radiation-based signal transmitting apparatus 1 according to the invention exceeds a hemisphere shape, the function of omni-directional radiation-based signals transmitting can be achieved.

In an embodiment, the first radiation-based signal transmitting components (E1˜E14), the second radiation-based signal transmitting components (E15˜E22) and the at least one third radiation-based signal transmitting component (E23) are an infrared transmitter respectively.

In an embodiment, furthermore, the first signal coverage zone of each first infrared transmitter (E1˜E14) is a first cone zone with a 35° cone angle, and N is an integer larger than or equal to 14. The first angle is about 80°.

In an embodiment, furthermore, the second signal coverage zone of each second infrared transmitter (E15˜E22) is a second cone zone with a 35° cone angle, and M is an integer larger than or equal to 8. The second angle is about 60°.

In an embodiment, the third signal coverage zone of each third infrared transmitter (E23) is a third cone zone with a 35° cone angle.

The first radiation-based signal transmitting components (E1˜E14), the second radiation-based signal transmitting components (E15˜E22) and the at least one third radiation-based signal transmitting component (E23) illustrated as an example in FIG. 1A are respectively a commercial infrared transmitter having a signal coverage zone with a 35° cone angle. To sum up, fourteen infrared transmitters are used as the first radiation-based signal transmitting components (E1˜E14), eight infrared transmitters are used as the second radiation-based signal transmitting components (E15˜E22), and one infrared transmitter is used as the third radiation-based signal transmitting component (E23). The first radiation-based signal transmitting components (E1˜E14) are surrounding into a circle. The second radiation-based signal transmitting components (E15˜E22) are also surrounding into a circle.

As shown in FIG. 1B, the driving circuit 12 includes three driving modules (U1, U2 and U3) and a power supply U4. The three driving module (U1, U2 and U3) can be Darlington transistor driving modules to increase the current signal response.

For driving twenty-three infrared transmitters (E1˜E23), the driving circuit 12 shown in FIG. 1B uses a capacitor C1 with capacitance greater than 1000 F which can provide short-term high current to drive twenty-three infrared transmitters (E1˜E23) simultaneously. In this case, the power supply U4 needs only 1.5 ampere current to provide required power. Besides, in this case, the driving circuit 12 also includes a diode D1 (as shown in FIG. 1A and FIG. 1B) to isolate the negative voltage generated by the discharging capacitor C1.

Basically, the resistance between the driving circuit 12 and each electrically connected infrared transmitter (E1˜E23) should be identical, to make the current through each infrared transmitter (E1˜E23) uniform. Besides, each infrared transmitter (E1˜E23) needs one 1 ohm resistor (R1˜R23) for restricting current. The resistors (E1˜E23) can be disposed inside the packages of the infrared transmitters (E1˜E23) for saving overall space of the omni-directional radiation-based signal transmitting apparatus 1 according to the invention.

With above explanation for the invention, it is clearly understood that the omni-directional radiation-based signal transmitting apparatus according to the invention can achieve the function of omni-directional transmitting of radiation-based signals without dead zone for signal coverage, and to ensure the certainty of remote control function.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An omni-directional radiation-based signal transmitting apparatus, comprising:
a circuit board, thereon defining a planar direction;
a driving circuit, soldered on the circuit board;
N first radiation-based signal transmitting components which each has a respective first transmitting central axis and a respective first signal coverage zone around the first transmitting central axis, the first radiation-based signal transmitting components being soldered on the circuit board and surrounding into a first closed shape such that the first transmitting central axis of each first radiation-based signal transmitting component makes a first angle with the planar direction of the circuit board and the first signal coverage zone of each first radiation-based signal transmitting component overlaps the first signal coverage zones of the neighboring first radiation-based signal transmitting components, each first radiation-based signal transmitting component being electrically connected to the driving circuit through the circuit board, N being an integer lager than or equal to 6;
M second radiation-based signal transmitting components which each has a respective second transmitting central axis and a respective second signal coverage zone around the second transmitting central axis, the second radiation-based signal transmitting components being soldered on the circuit board and surrounding into a second closed shape such that the second transmitting central axis of each second radiation-based signal transmitting component makes a second angle with the planar direction of the circuit board and the second signal coverage zone of each second radiation-based signal transmitting component overlaps the second signal coverage zones of the neighboring second radiation-based signal transmitting components, each second radiation-based signal transmitting component being electrically connected to the driving circuit through the circuit board, M being an integer lager than or equal to 6; and
at least one third radiation-based signal transmitting component which each has a respective third transmitting central axis and a respective third signal coverage zone around the third transmitting central axis, the at least one third radiation-based signal transmitting component being soldered on the circuit board such that the third transmitting central axis of each third radiation-based signal transmitting component is parallel to the planar direction of the circuit board and the third signal coverage zone of each third radiation-based signal transmitting component overlaps the third signal coverage zones of the neighboring third radiation-based signal transmitting components, each third radiation-based signal transmitting component being electrically connected to the driving circuit through the circuit board, wherein the driving circuit is for driving the first radiation-based signal transmitting components, the second radiation-based signal transmitting components and the at least one third radiation-based signal transmitting component simultaneously emitting radiation-based signals.

2. The omni-directional radiation-based signal transmitting apparatus of claim 1, wherein the first closed shape is a first circle, the second closed shape is a second circle located within the first circle, and the at least one third radiation-based signal transmitting component is located within the second circle.

3. The omni-directional radiation-based signal transmitting apparatus of claim 2, wherein the second signal coverage zone of each second radiation-based signal transmitting component overlaps the first signal coverage zones of the neighboring first radiation-based signal transmitting components and the third signal coverage zones of the neighboring third radiation-based signal transmitting components.

4. The omni-directional radiation-based signal transmitting apparatus of claim 3, wherein the first radiation-based signal transmitting components, the second radiation-based signal transmitting components and the at least one third radiation-based signal transmitting component are an infrared transmitter respectively.

5. The omni-directional radiation-based signal transmitting apparatus of claim 4, wherein the first signal coverage zone of each first infrared transmitter is a first cone zone with a 35° cone angle, and N is an integer larger than or equal to 14.

6. The omni-directional radiation-based signal transmitting apparatus of claim 5, wherein the first angle is about 80°.

7. The omni-directional radiation-based signal transmitting apparatus of claim 6, wherein the second signal coverage zone of each second infrared transmitter is a second cone zone with a 35° cone angle, and M is an integer larger than or equal to 8.

8. The omni-directional radiation-based signal transmitting apparatus of claim 5, wherein the second angle is about 60°.

9. The omni-directional radiation-based signal transmitting apparatus of claim 8, wherein the third signal coverage zone of each third infrared transmitter is a third cone zone with a 35° cone angle.
